(19) United States
(12) Patent Application Publication
(10) Pub. No.: US 2025/0192424 A1
(43) Pub. Date: Jun. 12, 2025

(54) VEHICULAR ANTENNA DEVICE

(71) Applicant: YOKOWO CO., LTD., Tokyo (JP)

(72) Inventors: Shuta MATSUMURA, Gunma (JP); Masashi NODA, Gunma (JP); Minoru ARATA, Gunma (JP)

(73) Assignee: YOKOWO CO., LTD., Tokyo (JP)

(21) Appl. No.: 18/840,924

(22) PCT Filed: Feb. 16, 2023
(86) PCT No.: PCT/JP2023/005372

§ 371 Date: Aug. 23, 2024

(30) Foreign Application Priority Data
Feb. 25, 2022 (JP) 2022-027404

(51) Int. Cl. H01Q 1/42; H01Q 1/32

(52) U.S. Cl. CPC H01Q 1/42; H01Q 1/3275

(57) ABSTRACT

The purpose of the present invention is to stably hold an antenna element of an onboard antenna device. This onboard antenna device comprises: an antenna element unit including an antenna element; an element holder for holding the antenna element; and a case that covers at least the antenna element and the element holder. The antenna element in sandwiched by the element holder and the case. The antenna element has a slit that extends in a second direction perpendicular to a first direction in which the element holder and the case sandwich the antenna element. A projection to be inserted into the slit is provided on the inner wall of the case. At least a portion of the case in a region thereof that contacts the antenna element is positioned further toward one side in the first direction than the region where the projection is provided. At least a portion of the element holder in a region thereof that contacts the antenna element is positioned further toward the other side in the first direction than the region where the projection is provided.

### TECHNICAL FIELD

The present invention relates to a vehicular antenna device.

### BACKGROUND ART

In the related art, as disclosed in Patent Literature 1, a vehicular antenna device (onboard antenna device) including a structure for holding an antenna element has been proposed.

### CITATION LIST

### Patent Literature

Patent Literature 1: JP2015-084575A

### SUMMARY OF INVENTION

### Technical Problem

However, stable holding of the antenna element is not sufficient. For example, a region of the antenna element away from a held portion may be moved by vibration or the like.

An object of the present invention is to stably hold an antenna element of a vehicular antenna device.

### Solution to Problem

A vehicular antenna device according to the present disclosure includes an antenna element portion including an antenna element, an element holder configured to hold the antenna element, and a case configured to cover at least the antenna element and the element holder. The antenna element is sandwiched between the element holder and the case. The antenna element includes at least one of a slit and a slot extending in a second direction perpendicular to a first direction in which the element holder and the case sandwich the antenna element. A projection to be inserted into the at least one of the slit and the slot is provided on an inner wall of the case. At least a part of a region of the case in contact with the antenna element is located further toward one side in the first direction than a region where the projection is provided. At least a part of a region of the element holder in contact with the antenna element is located further toward the other side in the first direction than the region where the projection is provided.

### Advantageous Effects of Invention

As described above, according to the present invention, the antenna element of the vehicular antenna device can be stably held.

### BRIEF DESCRIPTION OF DRAWINGS

FIG. 1 is a perspective view showing a state before an assembly of a case and a base portion and an exterior cover are attached in a first embodiment, when viewed from an upper front side.

FIG. 2 is a perspective view showing a state before the case, a first antenna, and an element holder are attached to a first substrate and the base portion in the first embodiment, when viewed from an upper rear side.

FIG. 3 is a perspective view showing a state before a waterproof member, a temporary fixing tool, a claw-equipped washer, and a bolt are attached to the assembly of the case and the base portion in the first embodiment, when viewed from a lower rear side.

FIG. 4 is a cross-sectional perspective view of a region where an upper stopper and a side stopper of the case are present in the first embodiment.

FIG. 5 is a cross-sectional perspective view of the case to which a twelfth element is attached in the first embodiment.

FIG. 6 is a cross-sectional perspective view of a region where an upper stopper and a side stopper of the case are present, an eleventh element, the twelfth element, and the element holder in the first embodiment.

FIG. 7 is a perspective view showing a state after the first antenna, the element holder, the first substrate, and the base portion are assembled in the first embodiment, when viewed from an upper rear side.

FIG. 8 is a rear perspective view showing a state before the first antenna is attached to the base portion to which the element holder and the first substrate are attached in the first embodiment.

FIG. 9 is an exploded perspective view of the first antenna, the element holder, and the second substrate in the first embodiment.

FIG. 10 is a perspective view of an assembly of a case and a base portion in a second embodiment when viewed from an upper front side.

FIG. 11 is a perspective view showing a state before the case, a first antenna, an element holder, a first helical element holder, a first substrate, and a metal plate are attached to a resin base in the second embodiment, when viewed from an upper rear side.

FIG. 12 is a perspective view showing a state before the first substrate, the metal plate, a pad, a waterproof member, a temporary fixing tool, a claw-equipped washers, and a bolt are attached to the resin base in the second embodiment, when viewed from a lower rear side.

FIG. 13 is a perspective view showing a state after the first antenna, the element holder, the first substrate, and the base portion are assembled in the second embodiment, when viewed from the upper rear side.

FIG. 14 is a perspective view of a connection fitting in second and third embodiments when viewed from a lower side.

FIG. 15 is an enlarged perspective view showing a state before the connection fitting screw; the connection fitting, the first substrate, and the metal plate are attached to the resin base in the second embodiment, when viewed from an upper side.

FIG. 16 is a perspective view showing a state before a case, a first antenna, a fifth antenna, an element holder, a second helical element holder, a first substrate, and a metal plate are attached to a resin base in the third embodiment, when viewed from an upper rear side.

### DESCRIPTION OF EMBODIMENTS

Hereinafter, the present embodiment will be described with reference to the drawings. Embodiments are not limited to the following embodiments. Further, contents described in one embodiment are similarly applied to other embodiments in principle. Further, the embodiments and modifications can be appropriately combined.

### First Embodiment

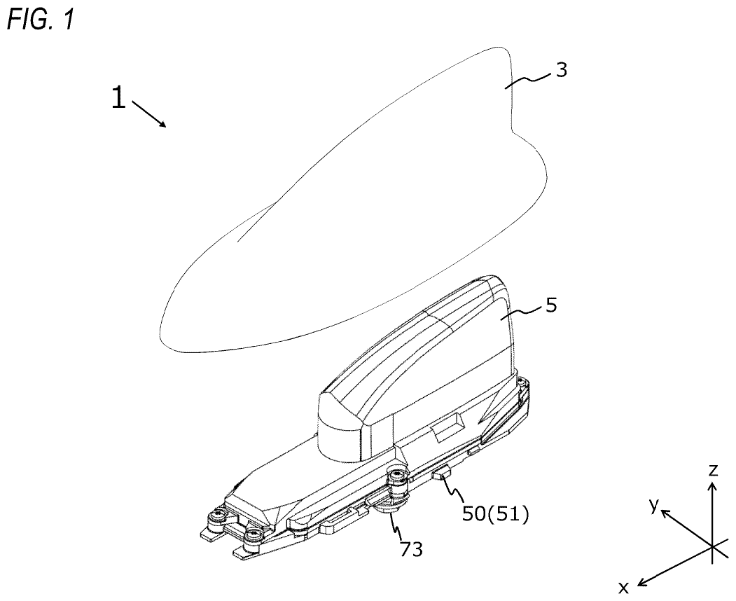

A vehicular antenna device 1 of a first embodiment is attached to an upper surface of a vehicle such as a roof. For example, as shown in FIGS. 1 to 3, the vehicular antenna device 1 includes an outer cover 3, a case 5, a pad 7, an element holder 10, an antenna element portion 20, a substrate portion 45, a connector 47, a base portion 50, a waterproof member 65, a temporary fixing tool 67, a claw-equipped washer 71, and a bolt 73.

In the following description, in order to describe directions, a front-rear direction of the vehicle to which the vehicular antenna device 1 is attached is defined as an x direction, a left-right direction perpendicular to the x direction is defined as ay direction, and a substantially vertical direction perpendicular to the x direction and the y direction is defined as a z direction. In FIG. 1, the directions indicated by respective arrows of xyz axes are defined as a forward direction, a rightward direction, and an upward direction.

### Outer Cover 3

The outer cover 3 is made of a synthetic resin having radio wave transparency. For example, the outer cover 3 is inclined such that a front side thereof in the x direction is lower than a rear side in the x direction, and has a shark-fin shape in which both side surfaces are curved inward. The outer cover 3 has an open lower surface and covers the case 5, the antenna element portion 20, or the like from an upper side in the z direction. The outer cover 3 is attached to the base portion 50 by snap fitting or the like. A pad (not shown) is provided between the outer cover 3 and the roof of the vehicle. The illustration of the outer cover 3 is omitted except for FIG. 1. The outer cover 3 may be omitted and the case 5 may be exposed.

Further, the case 5 or the like may be provided inside a region of the roof of the vehicle raised upward in the z direction. In this case, the outer cover 3 is omitted, and the base portion 50 and the like are attached to an inner panel or the like of the vehicle.

### Pad 7

The pad 7 is an annular elastic member made of elastomer, rubber, or the like. The pad 7 is sandwiched between a lower end peripheral edge portion of the case 5 and the base portion 50. The pad 7 prevents water from entering a space between the case 5 and the base portion 50.

### Connector 47

The connector 47 is mounted on a lower surface of a first substrate 45a. The connector 47 penetrates a hole of a metal base 51 and protrudes downward in the z direction. The connector 47 is electrically connected to a cable (not shown) extending from an electrical device (such as an audio device, not shown) of the vehicle.

### Base Portion 50

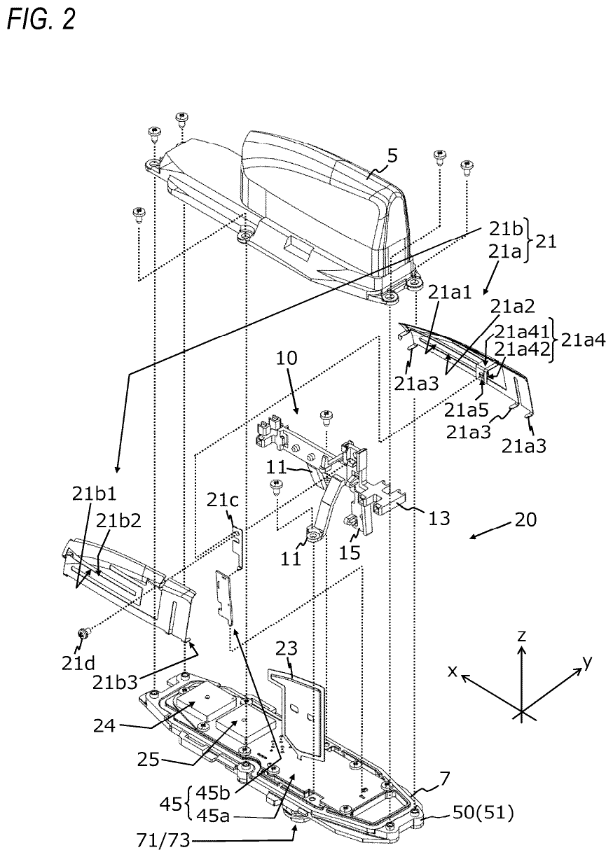

A base portion 50 of the first embodiment is implemented by the metal base 51. The metal base 51 is used as a ground plate of the vehicular antenna device 1. However, as described in a second embodiment and a third embodiment, the base portion 50 may include a metal plate 52 that is thinner than the metal base 51, and a resin base 55 that holds the metal plate 52. The metal base 51 holds the element holder 10 and the first substrate 45a (see FIG. 2).

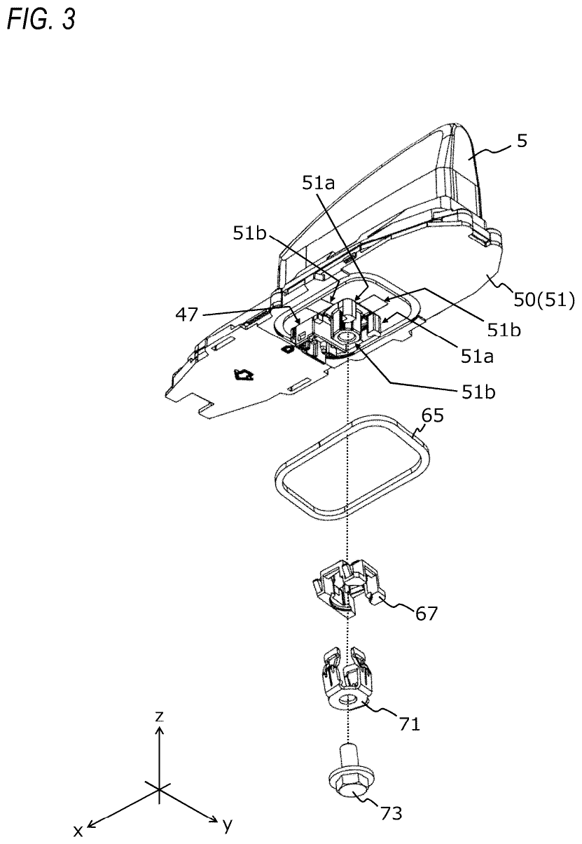

In a region of a lower surface of the metal base 51 facing an attachment hole of the roof of the vehicle, a rotation stop portion (first rotation stop portion 51a) protruding downward in the z direction and passing through the attachment hole is provided (see FIG. 3). The first rotation stop portion 51a is integrally formed with the lower surface of the metal base 51. The first rotation stop portion 51a comes into contact with a corner region of the attachment hole of the roof of the vehicle, and prevents rotation of the base portion 50 by rotation of the bolt 73.

A flat surface region is formed on the lower surface of the metal base 51 between a region facing the attachment hole of the roof of the vehicle and a region to which the waterproof member 65 is attached. When the vehicular antenna device 1 is fixed to the roof of the vehicle, the flat surface region (first roof contact surface 51b) is in contact with the roof.

### Waterproof Member 65

A waterproof member 65 such as a seal is attached to the lower surface of the metal base 51 in the periphery of the first rotation stop portion 51a. The waterproof member 65 is an elastic member having a surrounding shape formed of elastomer, rubber, urethane foam, or the like. The waterproof member 65 watertightly seals the periphery of a region between the metal base 51 and the roof of the vehicle where the attachment hole of the roof of the vehicle is provided.

### Temporary Fixing Tool 67

The temporary fixing tool 67 is made of a resin, and is attached to the lower surface of the metal base 51 in a region facing the attachment hole of the roof of the vehicle. The temporary fixing tool 67 is used for hooking (temporary tacking) to the roof of the vehicle before fastening the bolt 73.

### Claw-Equipped Washer 71 and Bolt 73

The claw-equipped washer 71 is deformed when the bolt 73 is fastened, and is in contact with a lower surface of the roof of the vehicle and the lower surface of the metal base 51.

### Case 5

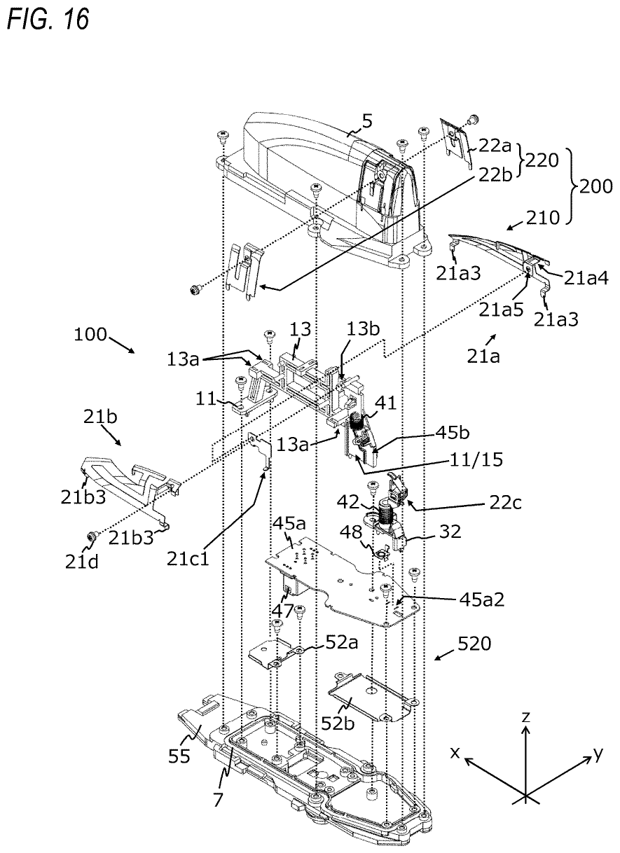

The case 5 is made of a synthetic resin having radio wave transparency. The lower surface of the case 5 is open. The case 5 covers the element holder 10, a first antenna 21, or the like. Accordingly, the element holder 10, the antenna element portion 20, the substrate portion 45, or the like are accommodated in a region (accommodation space) surrounded by the case 5 and the base portion 50. As in a third embodiment to be described later, a part of the antenna element portion 20 (fifth antenna 220, see FIG. 16) may be provided inside the outer cover 3 and outside the case 5.

### Projections 5a of Case 5

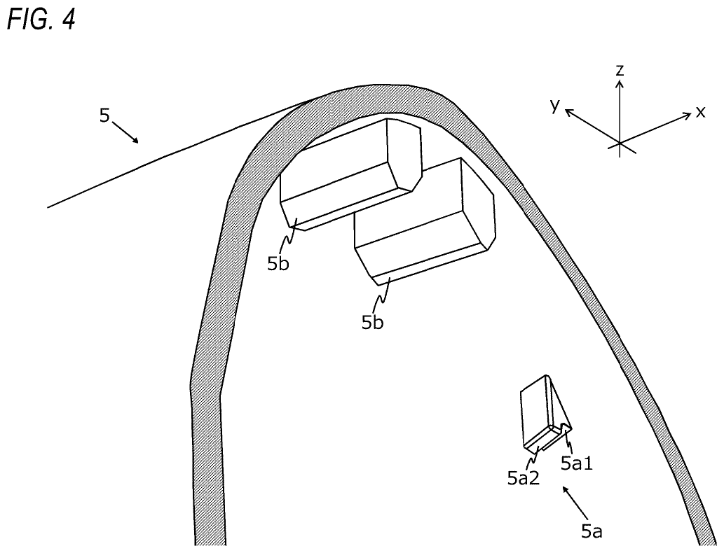

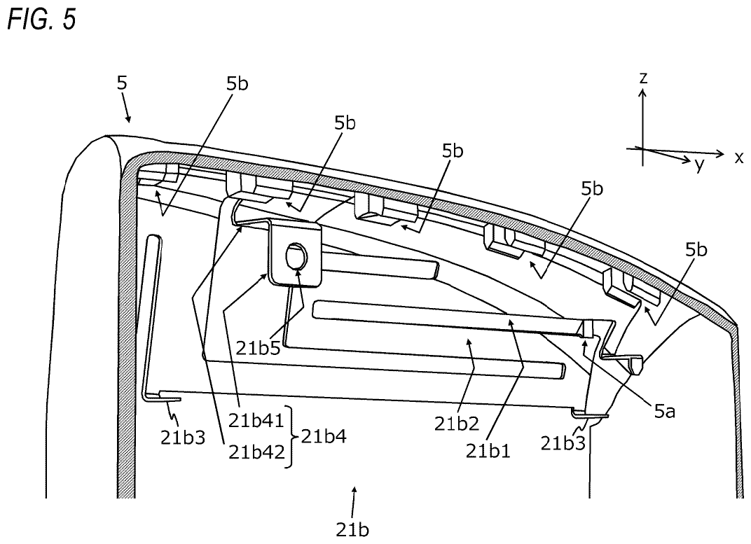

As shown in FIGS. 4 to 6, a projection (side stopper) 5a protruding leftward in the y direction is provided on a right side portion of an inner wall of the case 5. The projection (side stopper) 5a protruding rightward in the y direction is provided on a left side portion of the inner wall of the case 5. The projection 5a on the right side portion of the inner wall of the case 5 is provided at a position facing a slit (eleventh horizontal slit 21al) of an eleventh element 21a in the y direction when the case 5 is attached to the base portion 50. The projection 5a on the left side portion of the inner wall of the case 5 is provided at a position facing a slit (twelfth horizontal slit 21b1) of a twelfth element 21b in the y direction when the case 5 is attached to the base portion 50. In the first embodiment, the example in which the region into which the projection 5a is inserted is configured by a cut (slit) extending horizontally is shown, but the region may be configured by a hole (slot) extending horizontally.

A flat surface portion 5al substantially perpendicular to the z direction and a tip portion 5a2 extending downward in the z direction from a tip of the flat surface portion are formed at a lower portion of the projection 5a. A horizontally long region (eleventh horizontally long region 21a2) of the eleventh element 21a is in contact with the flat surface portion 5al of the projection 5a on the right side portion of the inner wall of the case 5. A horizontally long region (twelfth horizontally long region 21b2) of the twelfth element 21b is in contact with the flat surface portion 5al of the projection 5a on the left side portion of the inner wall of the case 5. The tip portion 5a2 of the projection 5a on the right side portion of the inner wall of the case 5 prevents the eleventh horizontally long region 21a2 of the eleventh element 21a from coming off the flat surface portion 5al. The tip portion 5a2 of the projection 5a on the left side portion of the inner wall of the case 5 prevents the twelfth horizontally long region 21b2 of the twelfth element 21b from coming off the flat surface portion 5al.

### Convex Portion 5b of Case 5

Convex portions (upper stoppers) 5b protruding downward in the z direction are provided on an upper portion of the inner wall of the case 5. An upper end portion of the eleventh element 21a is in contact with a right side portion of the convex portion 5b. The upper end portion of the twelfth element 21b is in contact with a left side portion of the convex portion 5b.

### Position at Which Case 5 and Eleventh Element 21a or the Like Are in Contact

At least a part of a region (the convex portion 5b) of the case 5 in contact with the eleventh element 21a or the twelfth element 21b is located above the region of the case 5 where the projection 5a is provided in the z direction.

The right side portion of the inner wall of the case 5 restricts rightward movement of the eleventh element 21a in the y direction. The left side portion of the inner wall of the case 5 restricts leftward movement of the twelfth element 21b in the y direction. The projection 5a on the right side portion of the inner wall of the case 5 limits upward movement of the eleventh horizontally long region 21a2 of the eleventh element 21a in the z direction. The projection 5a on the left side portion of the inner wall of the case 5 limits upward movement of the twelfth horizontally long region 21b2 of the twelfth element 21b in the z direction. The convex portion 5b restricts upward movement of the eleventh element 21a and the twelfth element 21b in the z direction.

### Element Holder 10

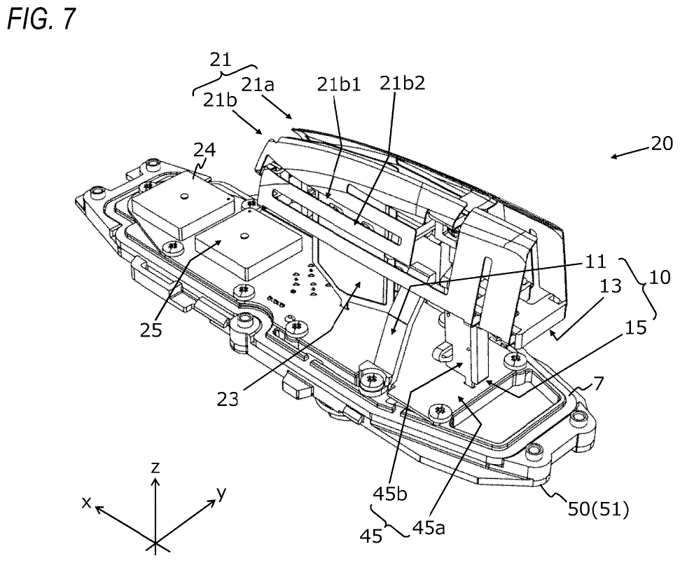

As shown in FIGS. 7 to 9, the element holder 10 holds the first antenna 21 of the antenna element portion 20. The element holder 10 is made of a resin. The element holder 10 includes leg portions 11, a holding portion 13, and a substrate holding portion 15.

One of the leg portions 11 extends in an obliquely upper right direction when viewed from the x direction, and the other leg portion 11 extends in an obliquely upper left direction when viewed from the x direction. The leg portion 11 has a substantially inverted V shape when viewed from the x direction. A lower end of the leg portion 11 is screwed to the base portion 50 (metal base 51). The holding portion 13 is formed above the leg portion 11 in the z direction.

However, the shape of the leg portion 11 is not limited to that described above. For example, as shown in the second embodiment, the leg portion 11 may extend in the z direction and have a substantially I-shape when viewed from the x direction. As shown in the third embodiment, a part of the leg portion 11 may be used as the substrate holding portion 15.

The holding portion 13 extends in the x direction. The holding portion 13 is provided with holding regions (protruding portion holding regions 13a) holding eleventh protruding portions 21a3 of the eleventh element 21a and twelfth protruding portions 21b3 of the twelfth element 21b. The protruding portion holding region 13a has a surface perpendicular to the z direction. The surface perpendicular to the z direction of the protruding portion holding region 13a limits downward movement of the eleventh element 21a and the twelfth element 21b in the z direction. In order to restrict the movement of the eleventh element 21a in the x direction and the leftward movement in the y direction, it is desirable to form walls on a front side in the x direction, on a rear side in the x direction, and on a right side in the y direction of the protruding portion holding region 13a that holds the eleventh element 21a. Further, in order to restrict the movement of the twelfth element 21b in the x direction and the rightward movement of the twelfth element 21b in the y direction, it is desirable to form walls on a front side in the x direction, on a rear side in the x direction, and on a left side in the y direction of the protruding portion holding region 13a that holds the twelfth element 21b. In this case, the protruding portion holding region 13a is formed in a region recessed from the periphery of the holding portion 13.

Position at which Element Holder 10 and Eleventh Element 21a or the Like are in Contact

At least a part of a region (protruding portion holding region 13a) of the element holder 10 in contact with the eleventh element 21a or the twelfth element 21b is located below the region of the case 5 where the projection 5a is provided in the z direction.

The holding portion 13 is provided with a hole (holding hole 13b) penetrating in the y direction. A ring-shaped convex portion 21c2 of a first connection terminal 21c is inserted into the holding hole 13b.

The substrate holding portion 15 extends downward in the z direction from the holding portion 13 and faces the first substrate 45a at a lower end thereof. The substrate holding portion 15 is located between the two leg portions 11 when viewed from the x direction. The substrate holding portion 15 holds a side surface of a second substrate 45b.

### Antenna Element Portion 20

The antenna element portion 20 constitutes an antenna element. The antenna element portion 20 includes a first antenna 21, a second antenna 23, a third antenna 24, and a fourth antenna 25.

### First Antenna 21

The first antenna 21 is, for example, an AM/FM antenna. The first antenna 21 includes an eleventh element 21a, a twelfth element 21b, and a first connection terminal 21c. For example, the eleventh element 21a and the twelfth element 21b are AM/FM capacitance loading elements. The eleventh element 21a and the twelfth element 21b are formed by processing a tin-plated steel plate (conductive plate). The eleventh element 21a and the twelfth element 21b are inclined such that lower sides thereof are separated from each other and upper sides thereof approach each other when viewed from the x direction. The eleventh element 21a has a gentle convex shape bulging in an obliquely upper right direction when viewed from the x direction. The twelfth element 21b has a gentle convex shape bulging in the obliquely upper left direction when viewed from the x direction.

The eleventh element 21a has a meander shape and includes at least the slit (eleventh horizontal slit 21al) extending in the substantially x direction and the horizontally long region (eleventh horizontally long region 21a2) extending in the substantially x direction. The eleventh horizontally long region 21a2 is provided below the eleventh horizontal slit 21al in the z direction and is adjacent to the eleventh horizontal slit 21al. The twelfth element 21b has a meander shape and includes at least the slit (twelfth horizontal slit 21b1) extending in the substantially x direction and the horizontally long region (twelfth horizontally long region 21b2) extending in the substantially x direction. The twelfth horizontally long region 21b2 is provided below the twelfth horizontal slit 21b1 in the z direction and is adjacent to the twelfth horizontal slit 21b1.

The eleventh element 21a is provided with the eleventh protruding portions 21a3 protruding leftward in the y direction from a meander region. It is desirable to provide the plurality of eleventh protruding portions 21a3. In this case, at least one eleventh protruding portion 21a3 of the plurality of eleventh protruding portions 21a3 is provided in a region below the eleventh horizontal slit 21al in the z direction. The eleventh protruding portion 21a3 is placed in the protruding portion holding region 13a of the element holder 10.

An eleventh connection region 21a4 is provided in the eleventh element 21a. The eleventh connection region 21a4 has a substantially L shape when viewed from the x direction. The substantially L shape of the eleventh connection region 21a4 includes an eleventh horizontal surface 21a41 that is substantially perpendicular to the z direction and extends leftward in the y direction from the meander region, and an eleventh vertical surface 21a42 that is substantially perpendicular to the y direction and extends downward in the z direction from a tip of the eleventh horizontal surface 21a41. An eleventh connection hole 21a5 penetrating in the y direction is formed in the eleventh vertical surface 21a42.

The twelfth element 21b is provided with the twelfth protruding portions 21b3 protruding rightward in the y direction from the meander region. It is desirable to provide the plurality of twelfth protruding portions 21b3. In this case, at least one twelfth protruding portion 21b3 of the plurality of twelfth protruding portions 21b3 is provided in a region below the twelfth horizontal slit 21b1 in the z direction. The twelfth protruding portion 21b3 is placed in the protruding portion holding region 13a of the element holder 10.

A twelfth connection region 21b4 is provided in the twelfth element 21b. The twelfth connection region 21b4 has a substantially L shape when viewed from the x direction. The substantially L shape of the twelfth connection region 21b4 includes a twelfth horizontal surface 21b41 that is substantially perpendicular to the z direction and extends rightward in the y direction from the meander shape portion, and a twelfth vertical surface 21b42 that is substantially perpendicular to the y direction and extends downward in the z direction from a tip of the twelfth horizontal surface 21b41. A twelfth connection hole 21b5 penetrating in the y direction is formed in the twelfth vertical surface 21b42.

An upper portion of the first connection terminal 21c is electrically connected to the eleventh element 21a and the twelfth element 21b. A lower portion of the first connection terminal 21c is electrically connected to the first substrate 45a via the second substrate 45b.

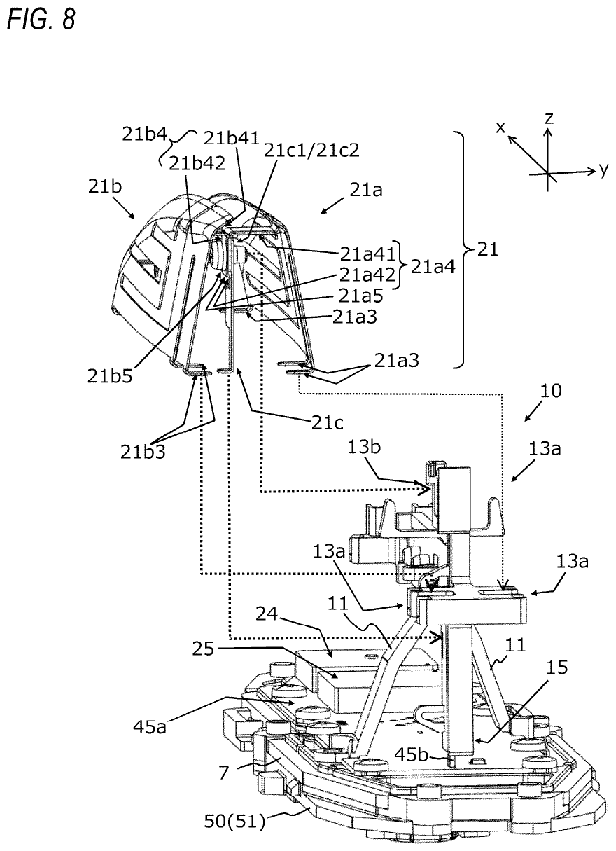

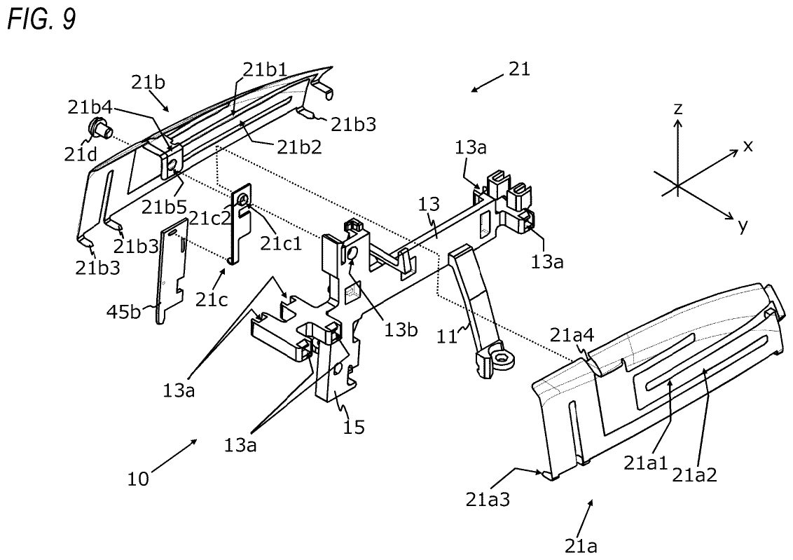

The first connection terminal 21c has a terminal hole portion 21c1 (see FIG. 9). A screw 21d for connecting the eleventh element 21a to the twelfth element 21b passes through the terminal hole portion 21cl. The terminal hole portion 21c1 is subjected to burling tap processing, and the ring-shaped convex portion 21c2 having a substantially hollow cylindrical shape is formed in the periphery of the terminal hole portion 21cl. The screw 21d for connecting the eleventh element 21a to the twelfth element 21b is screwed to a tap surface of the ring-shaped convex portion 21c2. The screw 21d is screwed into the ring-shaped convex portion 21c2 in a state where the screw 21d and the first connection terminal 21c sandwich the twelfth vertical surface 21b42 of the twelfth element 21b and the eleventh vertical surface 21a42 of the eleventh element 21a in the y direction (see FIG. 8). In FIG. 8, the second antenna 23 is not shown. Further, the ring-shaped convex portion 21c2 is inserted into the holding hole 13b of the holding portion 13 of the element holder 10.

### Second Antenna 23

The second antenna 23 is, for example, an antenna for mobile communication (see FIG. 7). The second antenna 23 is provided at a position where the second antenna 23 is sandwiched by the eleventh horizontally long region 21a2 of the eleventh element 21a and the twelfth horizontally long region 21b2 of the twelfth element 21b sandwich in the y direction. The second antenna 23 has a surface perpendicular to the y direction. The surface of the second antenna 23 perpendicular to the y direction is held by the holding portion 13 of the element holder 10. The second antenna 23 is attached to the first substrate 45a.

### Third Antenna 24

The third antenna 24 is, for example, an antenna for Sirius XM (SXM). The third antenna 24 is provided in front of the second antenna 23 in the x direction. The third antenna 24 is attached to the first substrate 45a.

### Fourth Antenna 25

The fourth antenna 25 is, for example, an antenna for a global navigation satellite system (GNSS). The fourth antenna 25 is provided between the second antenna 23 and the third antenna 24. The fourth antenna 25 is attached to the first substrate 45a.

### Substrate Portion 45

The substrate portion 45 includes the first substrate 45a and the second substrate 45b. The first substrate 45a has a surface perpendicular to the z direction. On the first substrate 45a, circuits related to the first antenna 21, the second antenna 23, the third antenna 24, and the fourth antenna 25 are mounted. The first substrate 45a holds the second antenna 23, the third antenna 24, the fourth antenna 25, and the second substrate 45b. The first substrate 45a is screwed to the base portion 50 (metal base 51).

The second substrate 45b has a surface perpendicular to the y direction. The circuit related to the first antenna 21 is mounted on the second substrate 45b. The second substrate 45b is held by the first substrate 45a and the substrate holding portion 15 of the element holder 10. The second substrate 45b may be directly attached to the first substrate 45a or may be attached to the first substrate 45a via a connection member such as an M-shaped fitting.

### Dimensions of Portions

Dimensions of the portions of the vehicular antenna device 1 are determined such that a distance between the region of the convex portion 5b on the inner wall of the case 5 in contact with the eleventh element 21a and the region of the protruding portion holding region 13a of the element holder 10 in contact with the eleventh element 21a is slightly shorter than a distance between the region of the eleventh element 21a in contact with the convex portion 5b and the region of the eleventh element 21a in contact with the protruding portion holding region 13a, and a force in the z direction is applied to the eleventh element 21a upon completion of assembly.

Dimensions of the portions of the vehicular antenna device 1 are determined such that a distance between the region of the convex portion 5b on the inner wall of the case 5 in contact with the twelfth element 21b and the region of the protruding portion holding region 13a of the element holder 10 in contact with the twelfth element 21b is slightly shorter than a distance between the region of the twelfth element 21b in contact with the convex portion 5b and the region of the twelfth element 21b in contact with the protruding portion holding region 13a, and a force in the z direction is applied to the twelfth element 21b upon completion of assembly.

### Attachment of Case 5, Element Holder 10, and First Antenna 21

Next, a configuration in which the first antenna 21 is sandwiched between the case 5 and the element holder 10 will be described. An assembly procedure will be described below; but the assembly procedure is not limited to the following. Further, FIGS. 2, 5, 8, and the like show a state in which several components are disassembled regardless of the following assembly procedure in order to facilitate understanding of an internal configuration.

The second antenna 23, the third antenna 24, and the fourth antenna 25 are attached to the first substrate 45a. A lower end of the first connection terminal 21c is hooked on the second substrate 45b. The first substrate 45a is attached to the metal base 51. The element holder 10) is attached to the metal base 51, and the second substrate 45b is attached to the first substrate 45a. The element holder 10 holds the side surface of the second substrate 45b and a side surface of the second antenna 23.

The eleventh vertical surface 21a42 of the eleventh element 21a and the twelfth vertical surface 21b42 of the twelfth element 21b overlap each other such that the eleventh connection hole 21a5 of the eleventh element 21a and the twelfth connection hole 21b5 of the twelfth element 21b overlap each other in the y direction. Further, in a state where the screw 21d and the first connection terminal 21c sandwich the eleventh vertical surface 21a42 and the twelfth vertical surface 21b42, the screw 21d is screwed to the ring-shaped convex portion 21c2 of the first connection terminal 21c. Thus, the eleventh element 21a, the twelfth element 21b, and the first connection terminal 21c are fixed to each other (see FIG. 8).

The ring-shaped convex portion 21c2 is inserted into the holding hole 13b of the element holder 10. The eleventh protruding portion 21a3 of the eleventh element 21a is placed on the protruding portion holding region 13a of the element holder 10. The twelfth protruding portion 21b3 of the twelfth element 21b is placed on the protruding portion holding region 13a of the element holder 10. Accordingly, the first antenna 21 is in a state of being attached to the element holder 10 (see FIG. 7).

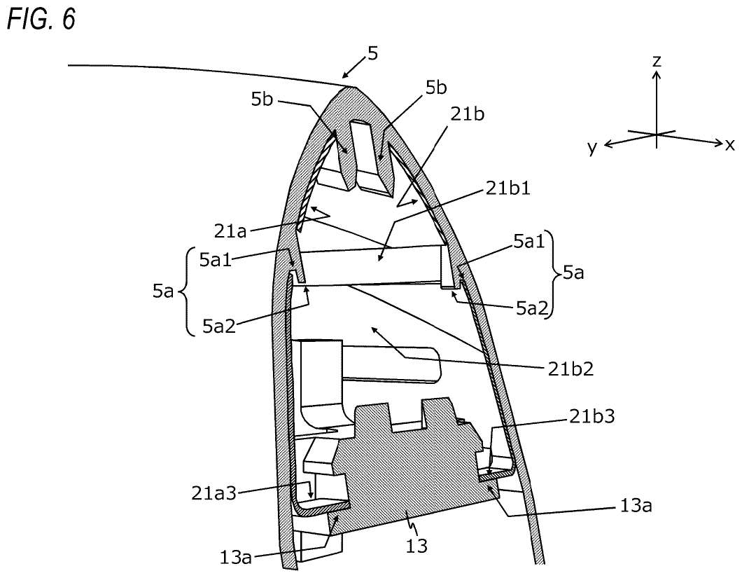

The case 5 is screwed to the metal base 51 with the pad 7 sandwiched therebetween. At this time, the upper end of the eleventh element 21a and the upper end of the twelfth element 21b are in contact with the convex portion 5b of the case 5. The projection 5a of the case 5 is inserted into the eleventh horizontal slit 21al of the eleventh element 21a and the twelfth horizontal slit 21b1 of the twelfth element 21b. The upper end of the eleventh horizontally long region 21a2 of the eleventh element 21a and the upper end of the twelfth horizontally long region 21b2 of the twelfth element 21b are in contact with the flat surface portion 5al of the projection 5a. The eleventh element 21a and the twelfth element 21b are in a state of being sandwiched between the convex portion 5b and the protruding portion holding region 13a in the z direction (see FIG. 6). An upward force in the z direction is applied to the eleventh horizontally long region 21a2 of the eleventh element 21a and the twelfth horizontally long region 21b2 of the twelfth element 21b, and the projection 5a restricts the upward movement in the z direction.

### Effect of Attaching First Antenna 21 to Element Holder 10

The first antenna 21 can be easily attached to another member (here, the element holder 10) compared with a configuration in which the first antenna 21 is attached to an inner wall of the outer cover 3, an outer wall of the case 5, or the like. Since the first antenna 21 is accommodated in a waterproof region (a region surrounded by the case 5 and the base portion 50), a degree of freedom of material selection of the eleventh element 21a or the like is increased compared with a configuration in which the first antenna 21 is provided outside the case 5. Further, electrical connection between the first antenna 21 and the first substrate 45a can also be easily performed.

### Effect of Sandwiching and Holding Eleventh Element 21a and Twelfth Element 21b

The eleventh element 21a is sandwiched in the z direction by the convex portion 5b of the inner wall of the case 5 and the protruding portion holding region 13a of the element holder 10. The twelfth element 21b is sandwiched in the z direction by the convex portion 5b of the inner wall of the case 5 and the protruding portion holding region 13a of the element holder 10. The convex portion 5b is located above the projection 5a in the z direction. The protruding portion holding region 13a is located below the projection 5a in the z direction. Therefore, the antenna element can be fixed to the holding member without using many fastening members such as screws. Further, since the case 5 and the element holder 10 sandwich the antenna element in a state where regions in contact with the antenna element (the eleventh element 21a and the twelfth element 21b) are separated from each other, the antenna element can be stably held, compared with a configuration where the case 5 and the element holder 10 sandwich the antenna element in a state where the regions in contact with the antenna element are close to each other.

### Effect of Providing Projections 5a

Although a force is applied to the eleventh element 21a and the twelfth element 21b from above and below; it is easy to keep the width of the slit constant, and the shapes (meander shapes) of the elements are hardly deformed. Therefore, electrical performance of the first antenna 21 can be easily maintained constant compared with a configuration in which the eleventh element 21a and the twelfth element 21b are deformed in shapes of the elements (meander shapes) by the force applied from above and below.

### Effect of Connection Using Holding Member Subjected to Burling Tap Processing

One of connection objects (first connection terminal 21c) is subjected to the burling tap processing to form the ring-shaped convex portion 21c2, and the remaining connection objects (the eleventh element 21a and the twelfth element 21b) are sandwiched by using the screw 21d and the ring-shaped convex portion 21c2. Accordingly, the electrical connection and fixation of the connection object can be easily performed with a small number of components.

### Application Example of Members Subjected to Burling Tap Processing

In the first embodiment, the example in which the terminal hole portion 21c1 of the first connection terminal 21c is subjected to the burling tap processing has been described. However, the eleventh connection hole 21a5 of the eleventh element 21a or the twelfth connection hole 21b5 of the twelfth element 21b may be subjected to the burling tap processing.

### Application Example of Holding Direction

In the first embodiment, the example in which the case 5 and the element holder 10 sandwich the antenna element (the eleventh element 21a or the like) in the z direction has been described. However, the direction in which the element holder 10 sandwiches the antenna element (the eleventh element 21a or the like) may be another direction. Also in this case, at least a part of the region (convex portion 5b) of the case 5 in contact with the antenna element (the eleventh element 21a or the like) is located further toward one side in the direction in which the antenna element is sandwiched than the region where the projection 5a is provided. At least a part of the region (protruding portion holding region 13a) of the element holder 10 in contact with the antenna element is located further toward the other side in the sandwiching direction than the region where the projection 5a is provided.

### Application Example of Base Portion 50, Second Embodiment

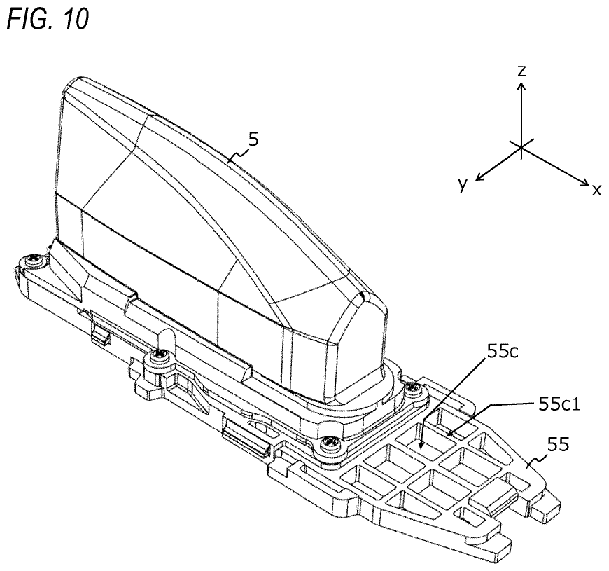

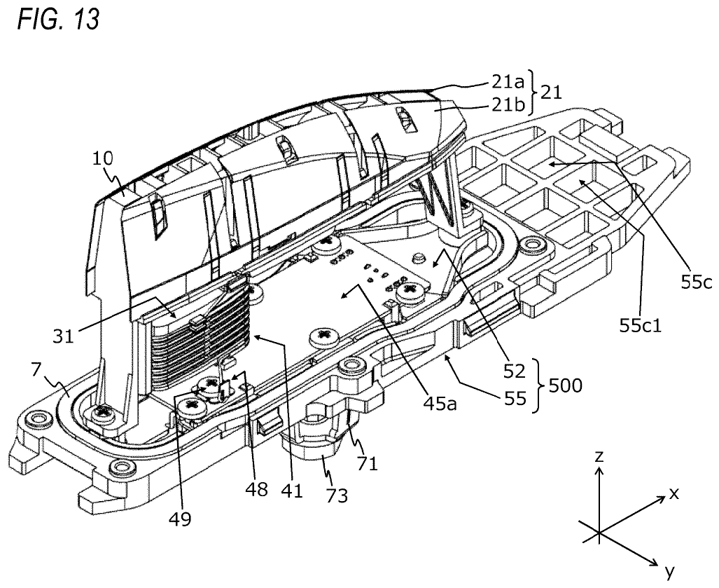

In the first preferred embodiment, the example in which the base portion 50 is implemented by the metal base 51 has been described. However, the base portion 50 may be partially or entirely made of a resin (see FIGS. 10 to 13).

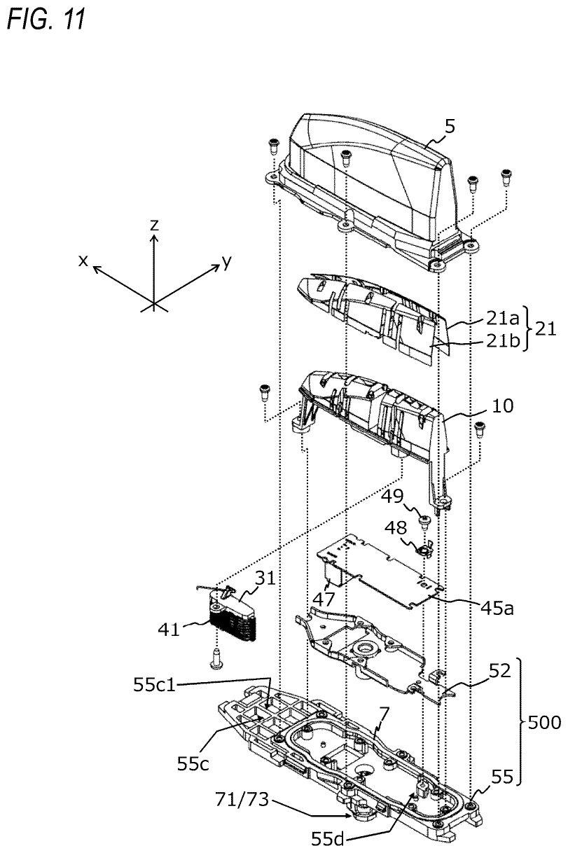

A base portion 500 of the second embodiment includes the metal plate 52 and the resin base 55 (see FIG. 11). The metal plate 52 is formed of one plate-shaped metal member, and is used as a ground plate of the vehicular antenna device 1. The metal plate 52 is formed, for example, on the resin base 55 so as to be accommodated inside a region where the pad 7 is disposed. The resin base 55 holds the element holder 10 and the metal plate 52. The metal plate 52 holds the first substrate 45a. Members constituting the vehicular antenna device 1 of the second embodiment that are functionally common to the members constituting the vehicular antenna device 1 of the first embodiment are denoted by the same reference numerals as those of the vehicular antenna device 1 of the first embodiment.

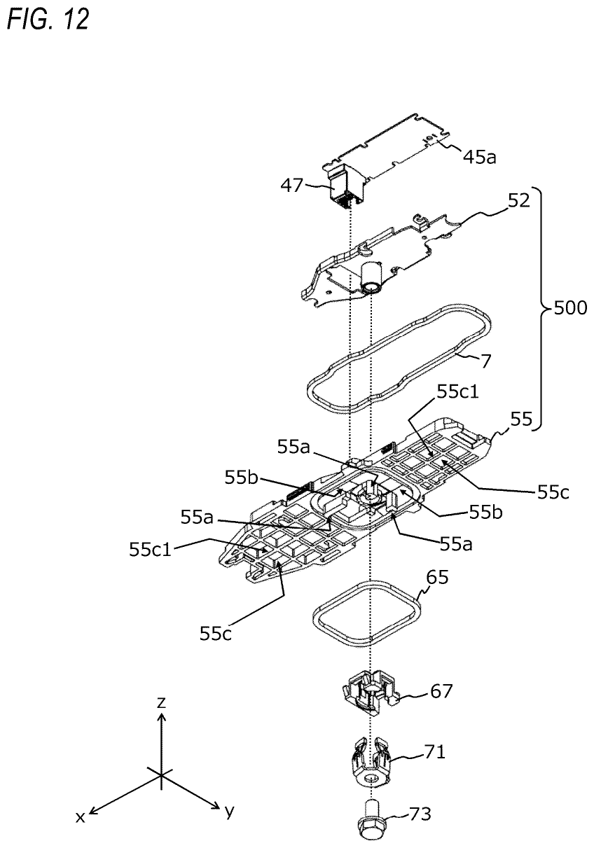

In a region of a lower surface of the resin base 55 facing an attachment hole of a roof of a vehicle, a rotation stop portion (second rotation stop portion 55a) protruding downward in the z direction and passing through the attachment hole is provided (see FIG. 12). The second rotation stop portion 55a is integrally formed with the lower surface of the resin base 55. The second rotation stop portion 55a comes into contact with a corner region of the attachment hole of the roof of the vehicle, and prevents rotation of the base portion 500 by rotation of the bolt 73.

A flat surface region is formed on the lower surface of the resin base 55 between a region facing the attachment hole of the roof of the vehicle and a region to which the waterproof member 65 is attached. When the vehicular antenna device 1 is fixed to the roof of the vehicle, the flat surface region (second roof contact surface 55b) is in contact with the roof.

A region of the resin base 55 in front of the region to which the waterproof member 65 is attached in the x direction and a region of the lower surface of the resin base 55 behind the region to which the waterproof member 65 is attached in the x direction are thinned (hollowed), and a rib 55c1 is formed between adjacent thinned regions 55c. The thinning may be performed so as to penetrate the resin base 55 in the z direction, or may be performed on at least one of an upper portion and a lower portion of the resin base 55 without penetrating resin base 55. That is, at least one of the upper surface and the lower surface of the resin base 55 is thinned. In the second embodiment, the example in which the region of the resin base 55 in front of the region to which the waterproof member 65 is attached in the x direction is thinned such that the resin base 55 is penetrated in the z direction is shown. Further, an example is shown in which only the lower portion of the resin base 55 in the region of the resin base 55 behind the region to which the waterproof member 65 is attached in the x direction is thinned.

Further, a connection fitting receiving portion 55d for screwing a connection fitting 48 is provided on the upper surface of the resin base 55. Details of the connection fitting receiving portion 55d will be described later.

Effect of Forming at Least Part of Base Portion 500 from Resin

The weight of the vehicular antenna device 1 can be reduced compared with a configuration in which the entire base portion 500 is made of metal. Further, it is easy to perform screwing while avoiding the region of the base portion 500 made of the metal, and it is possible to increase the number of portions that can be screwed from above in the z direction. Accordingly, the assembly work is facilitated as compared with a configuration in which the screwing is performed from the lower surface of the first substrate 45a or the like.

### Effect of Thinning Part of Resin Base 55

The weight of the vehicular antenna device 1 can be reduced as compared with a configuration in which thinning is not performed.

### Advantageous Effect of Providing Second Rotation Stop Portion 55A Made of Resin

In the case where the rotation stop portion is made of the metal as in the first rotation stop portion 51a, when the rotation stop portion comes into contact with the roof of the vehicle, electrical performance of the vehicular antenna device 1 may be affected. In the case where the rotation stop portion, such as the second rotation stop portion 55a, is made of a resin, when the rotation stop portion comes into contact with the roof of the vehicle, the electrical performance of the vehicular antenna device 1 is hardly affected.

### Effect of Providing Second Roof Contact Surface 55B Made of Resin

When the contact surface with the roof is made of the metal as in the first roof contact surface 51b, the electrical performance of the vehicular antenna device 1 may change depending on a degree of contact between the contact surface and the roof. In the case where the contact surface with the roof, such as the second roof contact surface 55b, is made of a resin, the electrical performance of the vehicular antenna device 1 is less likely to change depending on a degree of contact between the contact surface and the roof.

Application Example of Connection Method between First Antenna 21 and First Substrate 45a

In the first embodiment, the example in which the first antenna 21 and the first substrate 45a are connected to each other via the second substrate 45b has been described. However, the first antenna 21 and the first substrate 45a may be connected via a helical element (see FIGS. 11 and 13 to 15). The vehicular antenna device 1 of the second embodiment includes a first helical element holder 31, a first helical element 41, and a connection fitting 48.

### First Helical Element Holder 31 and First Helical Element 41

The first helical element holder 31 holds the first helical element 41. The first helical element holder 31 is disposed on the first substrate 45a and below the first antenna 21. One end portion of the first helical element 41 is electrically connected to the first antenna 21. The other end portion of the first helical element 41 is electrically connected to the first substrate 45a via the connection fitting 48.

### Connection Fitting 48

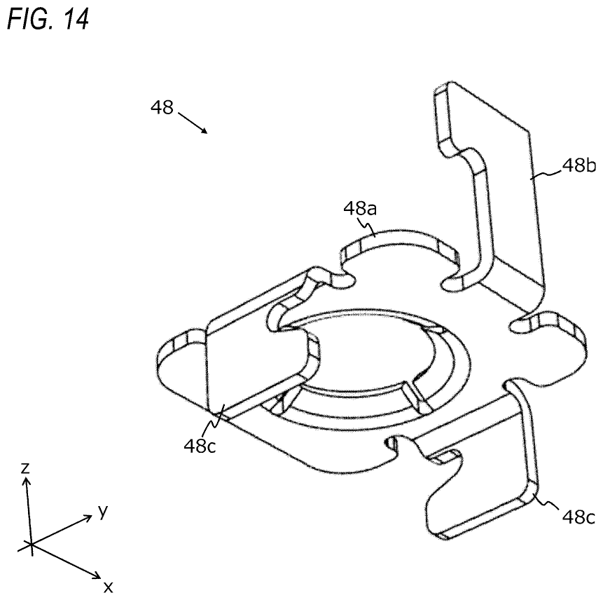

The connection fitting 48 of the second embodiment is used for connection between the first helical element 41 and the first substrate 45a. The connection fitting 48 includes a screw fixing portion 48a, a hook 48b, and bending stop portions 48c (see FIG. 14).

The screw fixing portion 48a has a surface perpendicular to the z direction, and a hole through which a shaft portion of a connection fitting screw 49 passes is formed in the surface. The hole is used for screwing using the connection fitting screw 49.

The hook 48b extends upward in the z direction from an end portion of the screw fixing portion 48a (for example, one of end portions in the y direction), and is used to hook the other end portion of the first helical element 41. The hook 48b of the second embodiment has a substantially L shape when viewed from the y direction.

The bending stop portions 48c extend downward in the z direction from the end portions of the screw fixing portion 48a (for example, both of the end portions in the x direction). A tip portion of the bending stop portion 48c is subjected to bending processing (clinching). The bending processing is used to prevent the connection fitting 48 from coming off from a member (for example, the first substrate 45a) adjacent to a lower side of the connection fitting 48 in the z direction. After the bending processing, the bending stop portion 48c is fixed to the member adjacent to the lower side of the connection fitting 48 in the z direction by soldering. The bending stop portion 48c of the second embodiment has a substantially L shape when viewed from the x direction.

In the fixing using the connection fitting 48, at least one of the screwing using the connection fitting screw 49 and the bending processing of the bending stop portions 48c is performed. When the bending processing is performed using the bending stop portions 48c, the fastening by the connection fitting screw 49 may not be performed. Further, when the connection fitting screw 49 is used for screwing, the bending processing of the bending stop portions 48c may not be performed. In the second embodiment, an example in which the screwing is performed using the connection fitting screw 49 and the bending processing using the bending stop portions 48c is not performed is described.

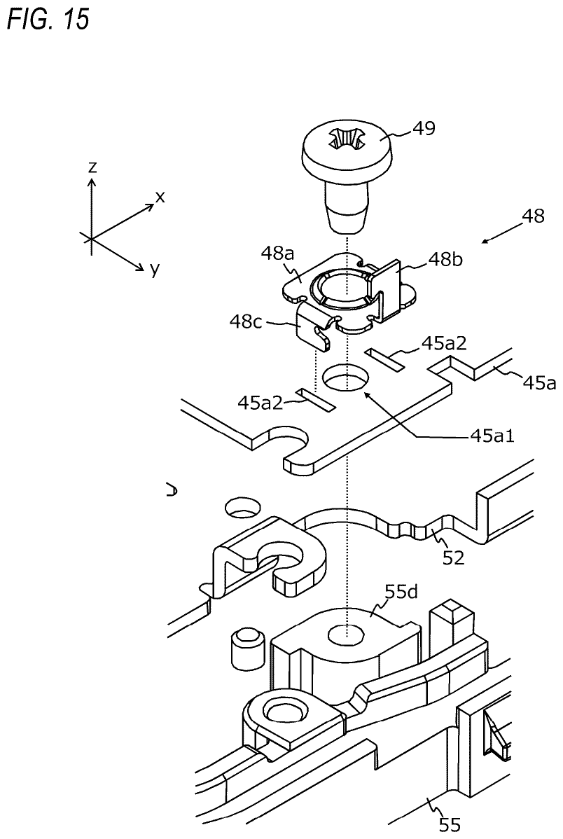

The first substrate 45a of the second embodiment is provided with holes (a first hole 45al and second holes 45a2) for attaching the connection fittings 48 (see FIG. 15). The first hole 45al is a circular hole through which the shaft portion of the connection fitting screw 49 passes. The second hole 45a2 is a substantially rectangular hole through which the bending stop portion 48c passes.

### Effects of Providing Connection Fitting 48

By performing at least one of the screwing using the connection fitting screw 49 and the bending processing (clinching) using the bending stop portions 48c, an adjacent connection target member (for example, the first substrate 45a) can be fixed. The fixing method can be selectively used according to a connection condition of the adjacent connection target member or the like by the one connection fitting 48. In the second embodiment, there is little possibility that the connection fitting screw 49 formed of the conductive member is electrically connected to a conductive member (for example, the metal plate 52) different from the adjacent connection target member. Accordingly, the screwing using the connection fitting screw 49 is performed without performing the bending processing using the bending stop portions 48c. In the third embodiment to be described later, the connection fitting screw 49 may be electrically connected to a conductive member (for example, a rear metal plate 52b) different from the adjacent connection target member. Accordingly, the fixing using the bending processing of the bending stop portions 48c is performed without using the connection fitting screw 49.

### Application Example of Antenna, Third Embodiment

In the first embodiment, the example in which the entire antenna element portion 20 (the first antenna 21 and the like) is accommodated inside the outer cover 3 and inside the case 5 has been described. However, a part (fifth antenna 220) of the antenna element portion 20 may be provided inside the outer cover 3 and outside the case 5 (see FIG. 16).

The vehicular antenna device 1 of the third embodiment includes a second helical element holder 32, a second helical element 42, an element holder 100, and an antenna element portion 200. The antenna element portion 200 of the third embodiment includes a first antenna 210 and the fifth antenna 220. Members constituting the vehicular antenna device 1 of the third embodiment that are functionally common to the members constituting the vehicular antenna device 1 of the first embodiment or the second embodiment are denoted by the same reference numerals as those of the vehicular antenna device 1 of the first embodiment or the second embodiment.

The first antenna 210 of the third embodiment corresponds to the first antenna 21 of the first embodiment. Members constituting the first antenna 210 of the third embodiment that are functionally common to the members constituting the first antenna 21 of the first embodiment are denoted by the same reference numerals as those of the first antenna 21 of the first embodiment. The element holder 100 of the third embodiment corresponds to the element holder 10 of the first embodiment. Members constituting the element holder 100 of the third embodiment that are functionally common to the members constituting the element holder 10 of the first embodiment are denoted by the same reference numerals as those of the element holder 10 of the first embodiment.

### Fifth Antenna 220)

The fifth antenna 220 is provided behind the first antenna 210 in the x direction. The fifth antenna 220 is, for example, a DAB antenna. The fifth antenna 220 includes a 21st element 22a, a 22nd element 22b, and a second connection terminal 22c. The 21st element 22a and the 22nd element 22b are formed by processing a SUS material (conductive plate). The 21st element 22a and the 22nd element 22b are inclined such that lower portions thereof are separated from each other and upper portions thereof approach each other when viewed from the x direction. The 21st element 22a has a gentle convex shape bulging in an obliquely upper right direction when viewed from the x direction. The 22nd element 22b has a gentle convex shape bulging in the obliquely upper left direction when viewed from the x direction. The 21st element 22a and the 22nd element 22b sandwich the case 5 in the y direction. The second connection terminal 22c is provided inside the case 5.

The 21st element 22a has a meander shape. The 21st element 22a is screwed to a right outer wall of the case 5 in the y direction. The 22nd element 22b has a meander shape. The 22nd element 22b is screwed to a left outer wall of the case 5 in the y direction. The 21st element 22a and the 22nd element 22b are electrically connected to the second helical element 42 via the second connection terminal 22c.

### Second Helical Element Holder 32 and Second Helical Element 42

The second helical element holder 32 is provided behind the element holder 10 in the x direction. The second helical element holder 32 holds the second helical element 42. The second helical element holder 32 is disposed on the first substrate 45a and below the fifth antenna 220. One end portion of the second helical element 42 is electrically connected to the fifth antenna 220. The other end portion of the second helical element 42 is electrically connected to the first substrate 45a via the connection fitting 48.

The connection fitting 48 of the third embodiment is used for connection between the second helical element 42 and the first substrate 45a. In order to avoid electrical connection with a metal plate 520) (the rear metal plate 52b), the connection fitting 48 and the first substrate 45a are fixed to each other by using the bending processing of the bending stop portions 48c without using the connection fitting screw 49. Therefore, in the first substrate 45a of the third embodiment, the second holes 45a2 are formed, and the first hole 45al is not formed.

### Application Example of Holding of Protruding Portions by Element Holder 100

In the first embodiment, the example in which surfaces of the eleventh protruding portions 21a3 of the eleventh element 21a and the twelfth protruding portions 21b3 of the twelfth element 21b, which are substantially perpendicular to the z direction, are held by the protruding portion holding regions 13a of the element holder 10 has been described. However, the other surfaces of the eleventh protruding portions 21a3 and the twelfth protruding portions 21b3 may be held by the protruding portion holding regions 13a.

The protruding portion holding region 13a of the element holder 100 of the third embodiment is recessed downward in the z direction. The eleventh protruding portion 21a3 of the eleventh element 21a of the third embodiment includes a first region protruding leftward in the y direction and a second region protruding downward in the z direction from a tip of the first region. The second region of the eleventh protruding portion 21a3 is inserted into a region recessed downward in the z direction of the protruding portion holding region 13a. Accordingly, the eleventh element 21a is held by the holding portion 13. The twelfth protruding portion 21b3 of the twelfth element 21b according to the third embodiment includes a first region protruding rightward in the y direction and a second region protruding downward in the z direction from a tip of the first region. The second region of the twelfth protruding portion 21b3 is inserted into a region recessed downward in the z direction of the protruding portion holding region 13a. Accordingly, the twelfth element 21b is held by the holding portion 13.

### Application Example of Metal Plate 52

In the second embodiment, the example in which the metal plate 52 is formed of one plate-shaped metal member has been described. However, the metal plate 52 may be formed of a plurality of plate-shaped metal members. The metal plate 520 of the third embodiment includes a front metal plate 52a and a rear metal plate 52b.

While certain embodiments of the present invention are described, these embodiments are presented by way of example only, and are not intended to limit the scope of the present invention. These embodiments can be implemented by various other forms, and various omissions, replacements, and modifications can be made without departing from the gist of the invention. These embodiments and modifications thereof are included in the scope and the gist of the invention, and are included in a scope equivalent to the inventions described in the claims.

According to the present specification, the following aspects are provided.

### Aspect 1

An vehicular antenna device includes an antenna element portion including an antenna element, an element holder configured to hold the antenna element, and a case configured to cover at least the antenna element and the element holder. The antenna element is sandwiched between the element holder and the case. The antenna element includes a slit extending in a second direction perpendicular to a first direction in which the element holder and the case sandwich the antenna element. A projection to be inserted into the slit is provided on an inner wall of the case. At least a part of a region of the case in contact with the antenna element is located further toward one side in the first direction than a region where the projection is provided. At least a part of a region of the element holder in contact with the antenna element is located further toward the other side in the first direction than the region where the projection is provided.

According to Aspect 1, the antenna element can be fixed to the holding member without using many fastening members such as screws. Further, the antenna element can be stably held by sandwiching the antenna element between the case and the element holder in a state where regions in contact with the antenna element are separated from each other. Although a force is applied to the antenna element, the width of the slit is easily kept constant, and the shape of the element is hardly deformed. Therefore, electrical performance of the antenna can be easily maintained constant.

### Aspect 2

The case preferably restricts movement of the antenna element toward the one side in the first direction. The element holder restricts movement of the antenna element toward the other side in the first direction.

### Aspect 3

Further, the projection is preferably formed with a flat surface portion perpendicular to the first direction and a tip portion extending from a tip of the flat surface portion to the one side in the first direction. A horizontally long region adjacent to the slit of the antenna element is in contact with the flat surface portion.

### Aspect 4

Further, the vehicular antenna device preferably includes a base portion. At least one of an upper surface and a lower surface of the base portion is thinned.

According to Aspect 4, the weight of the vehicular antenna device can be reduced as compared with a configuration in which thinning is not performed.

### Aspect 5

Further, the vehicular antenna device preferably includes a base portion. The base portion includes a rotation stop portion protruding downward and passing through an attachment hole of a roof of a vehicle.

According to Aspect 5, the rotation stop portion prevents rotation of the base portion.

### Aspect 6

Further, the base portion preferably includes a resin base. A flat surface region in contact with the roof is formed on a lower surface of the resin base between a region facing the attachment hole and a region to which a waterproof member is attached.

According to Aspect 6, in the case where a contact surface with the roof is made of a resin, the electrical performance of the vehicular antenna device is less likely to change depending on a degree of contact between the contact surface and the roof.

### Aspect 7

Further, the vehicular antenna device preferably includes a first substrate, and a connection fitting used for electrical connection between the antenna element and the first substrate and configured to be attached to the first substrate. The connection fitting includes a screw fixing portion in which a hole for screwing is formed and a bending stop portion. The connection fitting is attached to the first substrate by at least one of fixing by screwing through the hole for screwing and fixing by bending processing of the bending stop portion.

According to Aspect 7, the fixing method can be selectively used according to a connection condition of an adjacent connection target member or the like by the one connection fitting.

### Aspect 8

Further, the antenna element portion preferably includes a first element and a second element as the antenna element. The antenna element portion includes a connection terminal used for electrical connection between the antenna element and the first substrate. The first element, the second element, and the connection terminal are attached by screwing using a region subjected to burling tap processing in at least one of the first element, the second element, and the connection terminal.

According to Aspect 8, electrical connection and fixation of the connection object can be easily performed with a small number of components.

### Aspect 9

Further, the vehicular antenna device preferably includes a first substrate and a base portion configured to hold the first substrate. The antenna element and the element holder are accommodated in a region surrounded by the base portion and the case.

### Aspect 10

More preferably, the base portion includes a metal plate and a resin base that holds the metal plate.

According to Aspect 10, the weight of the vehicular antenna device can be reduced as compared with a configuration in which the entire base portion is made of metal.

### REFERENCE SIGNS LIST

1 vehicular antenna device
3 outer cover
5 case
5a projection (side stopper)
5al flat surface portion
5a2 tip portion
5b convex portion (upper stopper)
7 pad
10 (100) element holder
11 leg portion
13 holding portion
13a protruding portion holding region
13b holding hole
15 substrate holding portion
20 (200) antenna element portion
21 (210) first antenna
21a eleventh element
21al eleventh horizontal slit
21a2 eleventh horizontally long region
21a3 eleventh protruding portion
21a4 eleventh connection region
21a41 eleventh horizontal surface
21a42 eleventh vertical surface
21a5 eleventh connection hole
21b twelfth element
21b1 twelfth horizontal slit
21b2 twelfth horizontally long region
21b3 twelfth protruding portion
21b4 twelfth connection region
21b41 twelfth horizontal surface
21b42 twelfth vertical surface
21b5 twelfth connection hole
21c first connection terminal
21c1 terminal hole portion
21c2 ring-shaped convex portion
21d screw
22a 21st element
22b 22nd element
22c second connection terminal
23 second antenna (Tel)
24 third antenna (SXM)
25 fourth antenna (GPS)
220 fifth antenna (DAB)
31 first helical element holder
32 second helical element holder
41 first helical element
42 second helical element
45 substrate portion
45a first substrate
45al first hole
45a2 second hole
45b second substrate
47 connector
48 connection fitting
48a screw fixing portion
48b hook
48c bending stop portion
49 connection fitting screw
50 (500) base portion
51 metal base
51a first rotation stop portion
51b: first roof contact surface
52 (520)) metal plate
52a front metal plate
52b rear metal plate
55 resin base
55a second rotation stop portion
55b second roof contact surface
55c thinned region
55c1 rib
55d: connection fitting receiving portion
65 waterproof member
67 temporary fixing tool
71 claw-equipped washer
73 bolt

1. A vehicular antenna device comprising:
an antenna element portion including an antenna element;
an element holder configured to hold the antenna element; and
a case configured to cover at least the antenna element and the element holder, wherein
the antenna element is sandwiched between the element holder and the case,
the antenna element includes at least one of a slit and a slot extending in a second direction perpendicular to a first direction in which the element holder and the case sandwich the antenna element,
a projection to be inserted into the at least one of the slit and the slot is provided on an inner wall of the case,
at least a part of a region of the case in contact with the antenna element is located further toward one side in the first direction than a region where the projection is provided, and
at least a part of a region of the element holder in contact with the antenna element is located further toward the other side in the first direction than the region where the projection is provided.

2. The vehicular antenna device according to claim 1, wherein
the case restricts movement of the antenna element toward the one side in the first direction, and
the element holder restricts movement of the antenna element toward the other side in the first direction.

3. The vehicular antenna device according to claim 1, wherein
the projection is formed with a flat surface portion perpendicular to the first direction and a tip portion extending from a tip of the flat surface portion to the one side in the first direction, and
a horizontally long region adjacent to at least one of the slit and the slot of the antenna element is in contact with the flat surface portion.

4. The vehicular antenna device according to claim 1, further comprising:
a base portion, wherein
at least one of an upper surface and a lower surface of the base portion is thinned.

5. The vehicular antenna device according to claim 1, further comprising:
a base portion, wherein
the base portion includes a rotation stop portion protruding downward and passing through an attachment hole of a roof of a vehicle.

6. The vehicular antenna device according to claim 5, wherein
the base portion includes a resin base, and
a flat surface region in contact with the roof is formed on a lower surface of the resin base between a region facing the attachment hole and a region to which a waterproof member is attached.

7. The vehicular antenna device according to claim 1, further comprising:
a first substrate; and
a connection fitting used for electrical connection between the antenna element and the first substrate and configured to be attached to the first substrate, wherein
the connection fitting includes a screw fixing portion in which a hole for screwing is formed and a bending stop portion, and
the connection fitting is attached to the first substrate by at least one of fixing by screwing through the hole for screwing and fixing by bending processing of the bending stop portion.

8. The vehicular antenna device according to claim 4, wherein
the antenna element portion includes a first element and a second element as the antenna element,
the antenna element portion includes a connection terminal used for electrical connection between the antenna element and the first substrate, and
the first element, the second element, and the connection terminal are attached by screwing using a region subjected to burling tap processing in at least one of the first element, the second element, and the connection terminal.
